(19) United States
(12) Patent Application Publication
(10) Pub. No.: US 2009/0154178 A1
(43) Pub. Date: Jun. 18, 2009

(54) Method and apparatus to secure street light

(75) Inventor: Rodney W. Hall, Las Vegas, NV (US)

Correspondence Address: TOD R NISSLE, PO BOX 55630, PHOENIX, AZ, 85078, US

(73) Assignee: PAT SUPPLY, L.L.C., Las Vegas, NV (US)

(21) Appl. No.: 12/231,020

(22) Filed: Aug. 28, 2008

Related U.S. Application Data
(60) Provisional application No. 60/966,723, filed on Aug. 28, 2007.

(51) Int. Cl. F21S 13/10

(52) U.S. Cl. 362/431

(57) ABSTRACT

A street light includes an access opening, a cover for the access opening, at least one bolt to secure the cover in place over the access opening, and a locking unit to lock the cover in place and cover said bolt.

This application claims priority based on provisional application Ser. No. 60/966,723, filed Aug. 28, 2007.

This invention relates to street lights, and more particularly, to access covers for street lights.

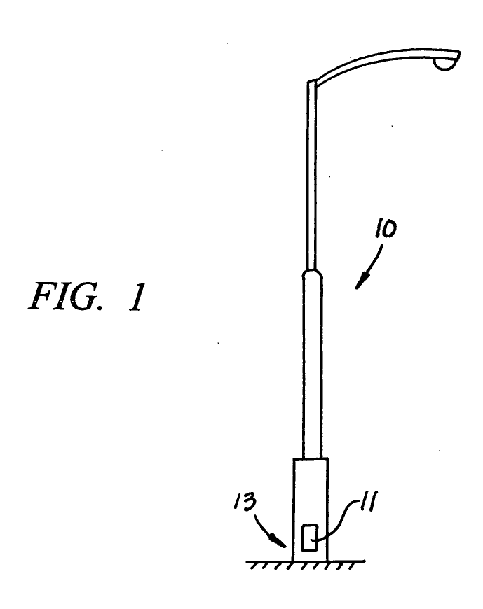

Street lights 10 include an access cover 11 mounted on the base, or lower portion, of light 10 (FIG. 1). Access cover 11 covers an access opening formed in the base of light 10. Unfortunately, such access covers 11 are typically secured in place with a screw or some other easily operated and removed fastener. As a result, in part because of the increasing value of copper, it has become commonplace in some areas for thieves to remove cover 11, reach through the access opening in the base of light 10 that was covered by access cover 11, and to then pull the copper wiring from the inside of the light 10, and out through the access opening. The shape of the access opening (and of cover 11) varies, but typically the opening has an orthogonal, or generally orthogonal, shape.

It is an object of the invention to provide and improved street light access cover.

These and other, further and more specific objects of the invention will be apparent from the following description, taken in conjunction with the drawings, in which:

FIG. 1 is an elevation view illustrating a street light;

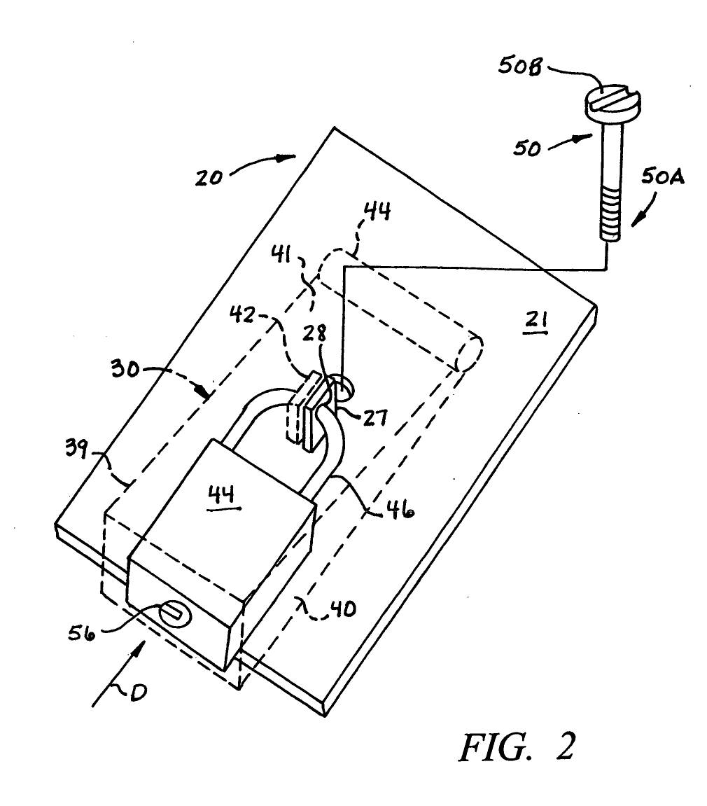

FIG. 2 is a perspective view illustrating one embodiment of a street light cover according to the invention;

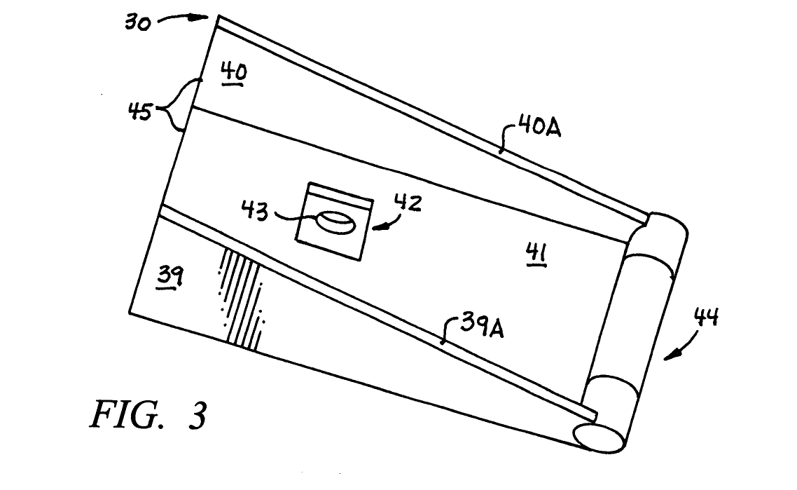

FIG. 3 is a perspective view illustrating one component of the street light cover of the embodiment of FIG. 2;

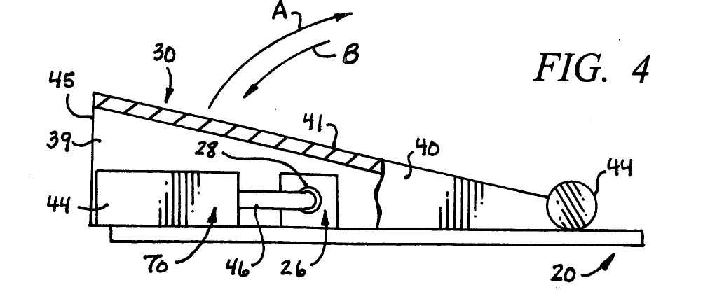

FIG. 4 is a side partial section view further illustrating the embodiment of FIG. 2;

FIG. 5 is a bottom view further illustrating the embodiment of the invention of FIG. 2;

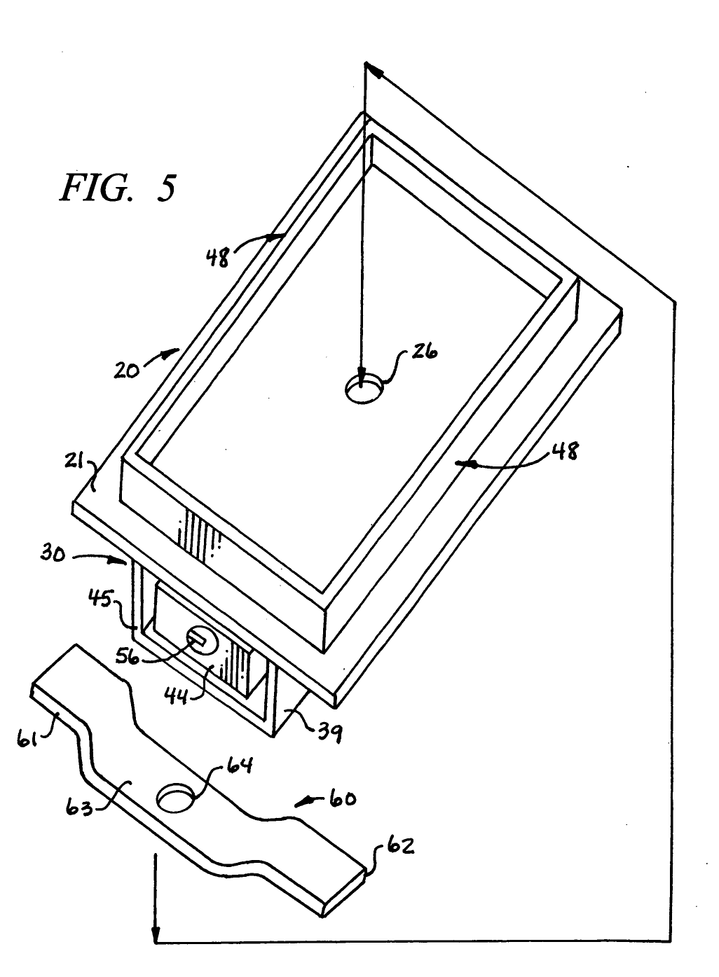

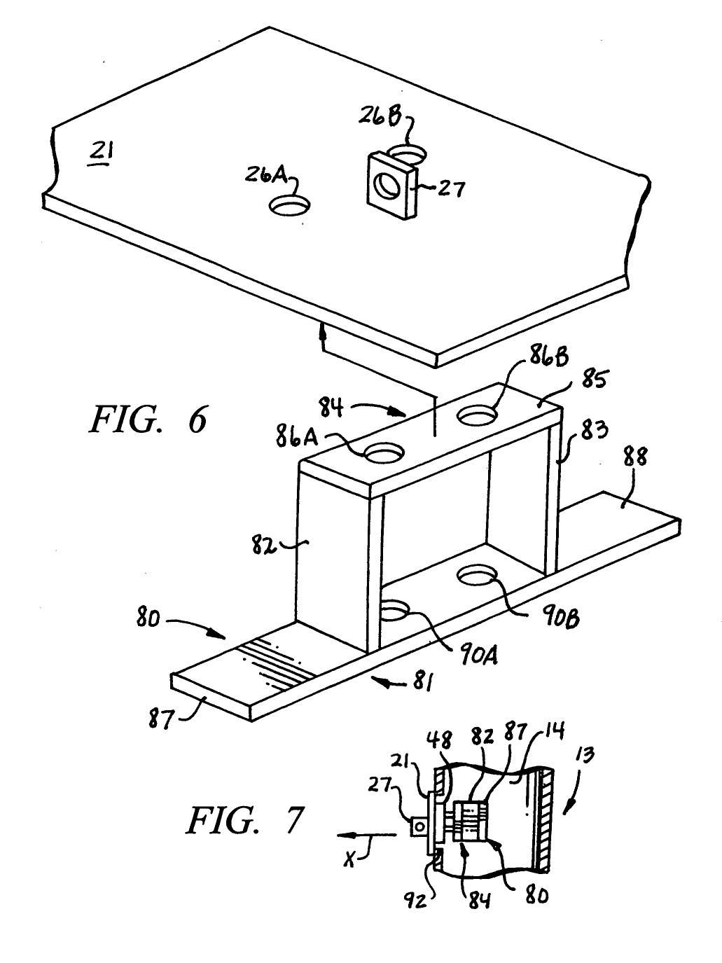

FIG. 6 is an exploded perspective view illustrating an alternate embodiment of the invention;

FIG. 7 is a side section view of a street light illustrating installation of the embodiment of the invention of FIG. 6;

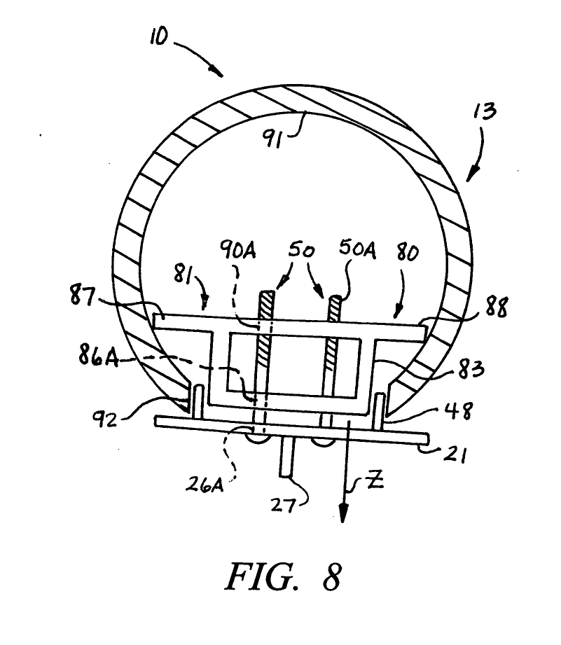

FIG. 8 is a top section view of a street light illustrating installation of the embodiment of the invention of FIG. 6;

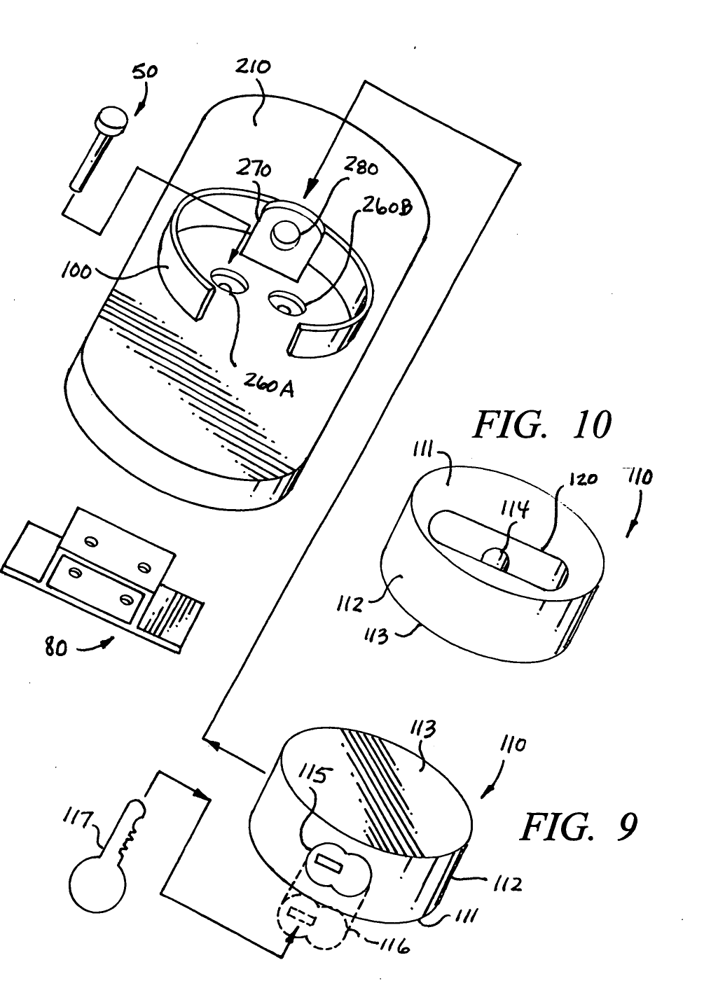

FIG. 9 is an exploded view illustrating still another embodiment of the invention; and,

FIG. 10 is a perspective view of a conventional lock utilized in the embodiment of the invention of FIG. 9.

Briefly, in accordance with the invention, I provide street light including an access opening and a locking cover to secure said access opening. The locking cover functions to protect a removable lock and to protect fasteners the secure the cover to feet that are located inside a street light pole and that are, with said fasteners, tightened against the inner surface of the street light pole to secure the cover in position over the access opening.

In the practice of the invention, cover 11 is removed and discarded and the security assembly illustrated in FIGS. 2 to 5 is utilized.

The security assembly includes a cover plate unit 20, a guard 30 operatively associated with plate unit 20, a lock 70, a screw 50, and a flange lock 60, All, or substantially all, portions of the security assembly are preferably made of steel or other strong, difficult to break materials.

The cover plate unit 20 is illustrated in FIGS. 2, 4, 5 and typically has a size comparable to that of discarded cover 11. The “top” or front of plate orthogonal plate 21 includes upstanding flange 27 with aperture 28 formed therethrough. Flange 27 is fixedly secured to plate 21. The “bottom” or back of plate 21 is clearly visible in FIG. 5 and includes orthogonal lip 48 that depends from, is fixedly attached to, and extends outwardly from the bottom of plate 21. Lip 48 is formed to slide into the access opening in light 10. The portion of plate 21 extending outwardly from lip 48 will not fit through the access opening and contacts and seats on portions of the base of light 10 that circumscribe and are adjacent the access opening.

The triangular guard 30 is illustrated in FIGS. 2 to 5 and includes orthogonal sloped top 41, triangular leg 40 fixedly attached and normal to top 41, triangular leg 39 fixedly attached and normal to top 41, and flange 42 fixedly attached and normal to and outwardly projecting from top 41. Aperture 43 is formed through flange 42. One end of top 41 and of each leg 39 and 40 is fixedly welded or otherwise attached to hinge 44. Hinge 44 is fixedly attached to plate 21 such that guard 30 can pivot about hinge 44 upwardly away from, and then back toward, plate 21 in the manner indicated by arrows A and B in FIG. 4.

Lock 40 is illustrated in FIGS. 2, 4, 5 and presently is a conventional lock of the MASTER LOCK™ variety. Lock 40 includes body 44 and generally semi-circular neck 46 that is moved between at least two operative positions, a first operative lock position in which neck 46 is pushed partially into body 44 in a locking position, and a second operative unlocked position in which neck 46 is pulled outwardly from body 44 and from the first operative position. In the unlocked position, one end of neck 46 is, in conventional fashion, spaced apart from body 44 so that neck 46 can be threaded or inserted through an opening prior to moving neck 46 to the locked position. In the locked position, both ends of neck 46 are positioned inside body 44.

Flange lock 60 is illustrated in FIG. 6 and includes base 63 and wings 61 and 62. Internally threaded aperture 64 is formed through base 63. Lock 60 is shaped and dimensioned such that it can be inserted in the access opening in the base of light 10 and positioned such that lock 60 spans complete across the access opening and the wings 61 and 62 extend past and underneath the peripheral edges of the access opening such that when lock 60 is displaced outwardly, wings 61 and 62 contact an inside surfaces inside the base of light 10, which inside surfaces prevent wings 61 and 62 (and therefore lock 60) from being pulled out through the access opening.

In use:

1. After cover 11 is removed from the access opening of light 10, and discarded, flange lock 60 is positioned inside the access opening of light 10 such that the lock completely spans the opening and wings 61 and 62 extend past the peripheral edge of the opening (this can also be accomplished after bolt 50 is inserted through opening 26 and is threaded a short distance into aperture 64).

2. Cover plate unit 20 is positioned on the access opening formed in light 10 such that lip 48 (FIG. 5) extends into the access opening, and such that the portions of plate 21 extending outwardly from lip 48 are seated on outer surface areas of light 10 that are adjacent and extend around the access opening.

3. Guard 30 is pivoted upwardly about hinge 44 in the direction of arrow A (FIG. 4) to an open position to expose flange 27 and opening 26 in plate 21. The externally threaded end 50A of bolt 50 is inserted through aperture 26 in plate 21 and is threaded into internally threaded aperture 64 of flange lock 60. The head 50B of bolt 50 is turned to continue threading end 50A into aperture 64 to draw plate 21 and flange lock 60 toward each other and to compress between wings 61 and 62 and the peripheral edge of plate 21 portions of the light 10 that extend around and adjacent the access opening in light 10. When bolt 50 is fully tightened, wings 61 and 62 and the peripheral edge of plate 21 (1) squeeze portions of light 10 extending around the access opening, (2) secure plate 21 and lock 60 in place, and (3) close and cover the access opening. This type of plate 21—flange lock arrangement is well known in the art with respect to street lights 10—although the particular plate unit 20 design utilized in the invention described herein is not believed to be known in the art.

4. After unit 20 is secured in place in the manner described in 3. above, guard 30 is pivoted about hinge 44 in the direction of arrow B (FIG. 4) from the open position to the closed position. The closed position of guard 30 is illustrated in FIGS. 2, 4, and 5.

5. After guard is pivoted to the closed position, flanges 27 and 42 are adjacent each other and aligned such that apertures 26 and 43 are in registration. Lock 70 is unlocked, and neck 46 in inserted through aligned apertures 26 and 43. After neck 46 is inserted through aligned apertures 36 and 43, lock 70 is locked. Locking lock 40 requires that the lock body 44 be pushed in the direction of arrow D in FIG. 2 such that neck 46 is forced into body 44 such that each end of neck 46 is seated inside body 44. When lock 40 is locked in the position illustrated in FIGS. 2, 4, 5, it is not possible to remove guard 30 from plate 21.

When lock 40 is locked, it is important that the portion of neck 46 that extends outwardly from body 44 be positioned “inside” guard 30 in the manner illustrated in FIGS. 2 and 4 and that no portions of neck 46 extend outwardly past the U-shaped back edge 45 of guard 30. If a portion of neck 46 extends outwardly past U-shaped edge 45, the it may be possible to use bolt cutters to cut through neck 46. In some cases, to prevent the use of bolt cutters on neck 46, it may be desirable to insure that the portions of neck 46 extending outwardly from body 44 actually be positioned inwardly from edge 45 in the manner illustrated in FIGS. 2 and 4.

A key (not shown) is inserted in opening 56 and turned to open and close lock 40 inconventional fashion.

FIGS. 6, 7, and 8 illustrate an alternate embodiment of the invention which is substantially structurally identical to the embodiment of the invention illustrated in FIGS. 2 to 5 except that flange lock 60 (FIG. 5) is replaced by flange lock 80 illustrated in FIGS. 6 to 8 and, instead of a single aperture 26 (FIG. 2), a pair of apertures 26A and 26B are formed through plate 21, each aperture 26A and 26B requiring a bolt 50.

Flange lock 80 includes orthogonal plate 81 with ends 87 and 88 and internally threaded apertures 90A and 90B formed therethrough, includes plate 84 with upper planar surface 85 and with apertures 86A and 86B formed therethrough, and includes plates 82 and 83 normal to and interconnecting parallel plates 81 and 84.

In use of the embodiment of the invention of FIGS. 6 to 8:
1. After cover 11 is removed from the access opening of light 10, and discarded, flange lock 80 is positioned inside the access opening 92 (FIGS. 7 and 8) formed in the base 13 of light 10 such that plate 81 of lock 80 completely spans the opening 92 and ends 87 and 88 each extend past the peripheral edge of the opening 92 (this can also be accomplished after bolts 50 are each inserted through one of the aligned opening groupings 26A-86A-90A and 26B-86B-90B and is threaded a short distance into internally threaded opening 90A or 90B, as the case may be).
2. Cover plate unit 20 is positioned on the access opening 92 such that lip 48 extends into the access opening (FIGS. 7 and 8) and such that the peripheral portions of plate 21 extending outwarldy from lip 48 are seated on outer surface areas of light 10 that are adjacent and extend around the access opening 92.
3. Guard 30 is pivoted upwardly about hinge 44 in the direction of arrow A (FIG. 4) to an open position to expose flange 27 and opening 26 in plate 21. The externally threaded end 50A of each bolt 50 is inserted one of the opening groupings 26A-86A-90A and 26B-86B-90B and is threaded into internally threaded opening 90A or 90B, as the case may be, to draw flange lock 80 in the direction of arrow Z in FIG. 8 until ends 87 and 88 press securely against the cylindrical inner wall 91 of the base 13 of light 10 in the manner illustrated in FIG. 8; and, such that plate 21 is drawn tightly against the outside of base 13. In FIG. 8, plate 21 is not yet drawn completely against the outside of base 13, but would be after bolts 50 are turned further through apertures 90A and 90B to draw plate 21 against the outside of base 13 at points adjacent the periphery of opening 92. After bolts 50 are turned through apertures 90A and 90B a distance sufficient to draw ends 87 and 88 against inner wall 91 and draw plate 21 against the outside of base 13, the plate 21 and lock 80 are securely fixed in position in base 13.
4. After unit 20 is secured in place in the manner described in 3. above, guard 30 is pivoted about hinge 44 in the direction of arrow B (FIG. 4) from the open position to the closed position. The closed position of guard 30 is illustrated in FIGS. 2, 4, and 5.
5. After guard is pivoted to the closed position, flanges 27 and 42 are adjacent each other and aligned such that apertures 26 and 43 are in registration. Lock 70 is unlocked, and neck 46 in inserted through aligned apertures 26 and 43. After neck 46 is inserted through aligned apertures 36 and 43, lock 70 is locked. Locking lock 40 requires that the lock body 44 be pushed in the direction of arrow D in FIG. 2 such that neck 46 is forced into body 44 such that each end of neck 46 is seated inside body 44. When lock 40 is locked in the position illustrated in FIGS. 2, 4, 5, it is not possible to remove guard 30 from plate 21.

When lock 40 is locked, it is important that the portion of neck 46 that extends outwardly from body 44 be positioned “inside” guard 30 in the manner illustrated in FIGS. 2 and 4 and that no portions of neck 46 extend outwardly past the U-shaped back edge 45 of guard 30. If a portion of neck 46 extends outwardly past U-shaped edge 45, the it may be possible to use bolt cutters to cut through neck 46. In some cases, to prevent the use of bolt cutters on neck 46, it may be desirable to insure that the portions of neck 46 extending outwardly from body 44 actually be positioned inwardly from edge 45 in the manner illustrated in FIGS. 2 and 4.

An alternate embodiment of the invention is illustrated in FIGS. 9 and 10 and generally is utilized in the same manner as the embodiments of the invention discussed in FIGS. 1 to 8. The embodiment of the invention in FIGS. 9 and 10 utilizes the same bolts 50 as the embodiments of the invention in FIGS. 1 to 8, and utilizes the same flange lock 80 as the embodiment of the invention in FIGS. 6 to 8. The embodiment of the invention in FIGS. 9 and 10 includes a plate 210 with bolt receiving apertures 260A, 260B formed therethrough, with semi-circular upstanding collar 100 fixedly attached thereto, and with upstanding flange 270. Aperture 280 is formed through flange 270.

Conventional lock 110 includes back 111, front 113, cylindrical side 112, and locking cylinder 115. When cylinder 115 is in the closed position illustrated in FIGS. 9 and 10, a pin 114 extends across slot 120 formed in the back 111. When key 117 is inserted in cylinder 115 and used to unlock cylinder and outwardly slidably move cylinder to the position illustrated by dashed lines 116, the pin 114 no longer extends across slot 120 and slot 120 is completely open. When lock 110 is in this open configuration, it can be placed within collar 100 with back 111 facing and contacting plate 210 and with flange 270 extending upwardly into slot 120. Key 117 is then used to close lock 110. When lock 110 is closed, cylinder 115 slides back to the closed position of FIG. 9, and, pin 114 moves into, and in part, through aperture 280. When pin 114 extends through aperture 280, lock 110 can not be moved from plate 210 and from within collar 100.

Consequently, in use, bolts 50 are inserted through apertures 260A and 260B and into flange lock 80, flange lock 80 is positioned inside a light pole, and bolts 50 are tightened to anchor flange lock 80 against the inside of the light pole and secure plate 210 on the outside of the light pole over the access opening to the light pole in the manner earlier described. Lock 110 is then positioned inside collar 100 and locked to pin 114 extends through aperture 280 and secures lock 110 in placed. Lock 110 covers and protects the head of bolts 50.

1. A street light including an access opening, a cover for the access opening, at least one bolt to secure the cover in place over the access opening, and a locking unit to lock the cover in place and cover said bolt.
